(19) United States
(12) Patent Application Publication
(10) Pub. No.: US 2007/0050767 A1
(43) Pub. Date: Mar. 1, 2007

(54) Method, apparatus and system for a virtual diskless client architecture

(76) Inventors: Steven L. Grobman, El Dorado Hills, CA (US); David I. Poisner, Folsom, CA (US)

Correspondence Address: INTEL CORPORATION;C/O INTELLEVATE, LLC, P.O. BOX 52050, MINNEAPOLIS, MN, 55402, US

(21) Appl. No.: 11/218,072

(22) Filed: Aug. 31, 2005

(51) Int. Cl. G06F 9/455

(52) U.S. Cl. 718/1

(57) ABSTRACT

A method, apparatus and system enable a virtual diskless architecture on a virtual machine (“VM”) host. In one embodiment, a partition on the VM host may be designated a management VM and the storage controller (coupled to a storage device) on the host VM may be dedicated to this management VM. Thereafter, a second VM on the host may connect to management VM via a virtual network connection and access data on the “remote” storage device via the virtual network connection.

### BACKGROUND

Interest in virtualization technology is growing steadily as processor technology advances. One aspect of virtualization technology enables a single host computer running a virtual machine monitor (“VMM”) to present multiple abstractions and/or views of the host, such that the underlying hardware of the host appears as one or more independently operating virtual machines (“VMs”). Each VM may function as a self-contained platform, running its own operating system (“OS”) and/or a software application(s). The VMM manages allocation of resources on the host and performs context switching as necessary to cycle between various VMs according to a round-robin or other predetermined scheme.

### BRIEF DESCRIPTION OF THE DRAWINGS

The present invention is illustrated by way of example and not limitation in the figures of the accompanying drawings in which like references indicate similar elements, and in which:

FIG. 1 illustrates an example of a typical virtual machine host;

FIG. 2 illustrates an embodiment of the present invention in further detail;

FIG. 3 illustrates an alternative embodiment of the present invention in further detail;

FIG. 4 is a flowchart illustrating an embodiment of the present invention; and

FIG. 5 illustrates yet another embodiment of the present invention in further detail.

### DETAILED DESCRIPTION

Embodiments of the present invention provide a method, apparatus and system for a virtual diskless architecture. More specifically, according to embodiments of the present invention, various aspect of virtualization may be leveraged to provide a virtual diskless environment. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

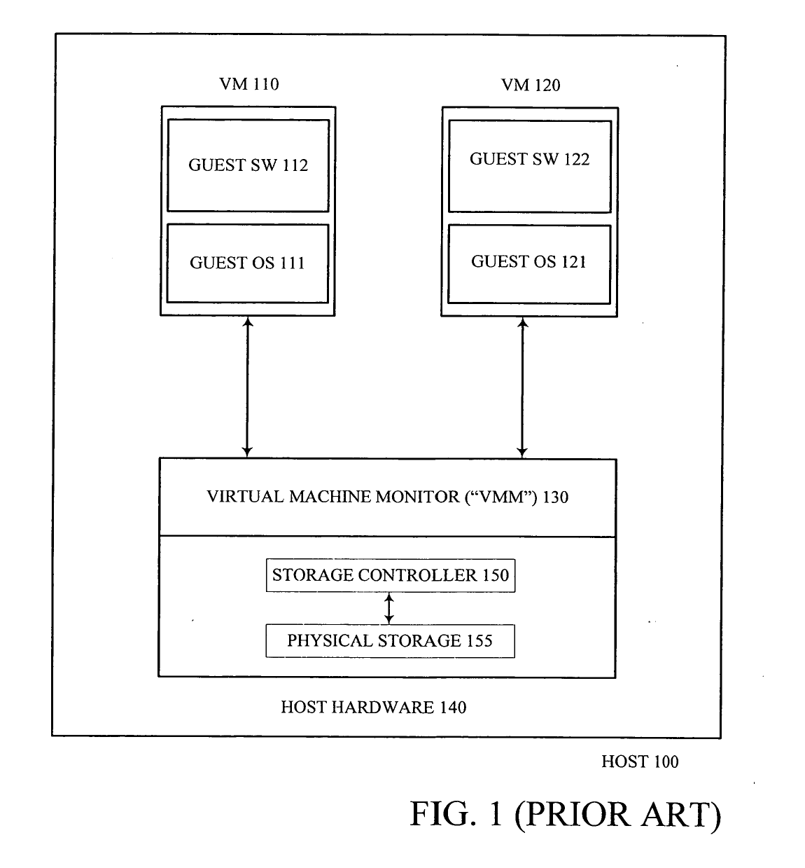

In order to facilitate understanding of embodiments of the invention, FIG. 1 illustrates an example of a typical virtual machine host platform (“Host 100”). As previously described, a virtual-machine monitor (“VMM 130”) typically runs on the host platform and presents an abstraction(s) and/or view(s) of the platform (also referred to as “virtual machines” or “VMs”) to other software. Although only two VM partitions are illustrated (“VM 110” and “VM 120”, hereafter referred to collectively as “VMs”), these VMs are merely illustrative and additional virtual machines may be added to the host. VMM 130 may be implemented in software (e.g., as a standalone program and/or a component of a host operating system), hardware, firmware and/or any combination thereof.

VM 110 and VM 120 may function as self-contained platforms respectively, running their own “guest operating systems” (i.e., operating systems hosted by VMM 130, illustrated as “Guest OS 111” and “Guest OS 121” and hereafter referred to collectively as “Guest OS”) and other software (illustrated as “Guest Software 112” and “Guest Software 122” and hereafter referred to collectively as “Guest Software”). Each Guest OS and/or Guest Software operates as if it were running on a dedicated computer rather than a virtual machine. That is, each Guest OS and/or Guest Software may expect to control various events and have access to hardware resources on Host 100. Within each VM, the Guest OS and/or Guest Software may behave as if they were, in effect, running on Host 100's physical hardware (“Host Hardware 140”). Host Hardware 140 may include, for example, a storage controller (“Storage Controller 150”) coupled to a physical storage drive (“Physical Storage 155”).

VMM 130 may be “hosted” (i.e., a VMM that is started from and under the control of a host operating system) or unhosted (e.g., a “hypervisor”). In either scenario, each Guest OS in the VMs believes that it fully “owns” Host 100's hardware and multiple VMs on Host 100 may attempt simultaneous access to certain resources on Host 100. For example, the VMs may both try to access the same file on Host 100. Since Host 100's file system resides on Physical Drive 155, this scenario may result in a contention for Storage Controller 150 because both VMs may believe that they have full access to Storage Controller 150. Although VMM 130 may currently handle this situation according to known arbitration schemes, various security problems may arise as a result.

According to embodiments of the present invention, multiple VMs may securely and concurrently access data on Host 100. More specifically, VMM 130 may designate one of the VMs on Host 100 as a “management” or primary partition and designate the other partition(s) on Host 100 as “user” or secondary partitions. By doing so, embodiments of the invention may enable the management partition to “own” the file system on Host 100 while creating the illusion to the user partition that it is operating as a diskless platform and accessing data from a “remote” location. In other words, the user partition is fooled into believing that it is accessing data on a remote file system while in reality, the file system storage is local to Host 100. This scheme effectively takes advantage of various network and/or diskless architecture technologies to ensure secure and concurrent access to data on Host 100 and eliminates the potential conflicts and/or security breaches that may arise if Host 100's file system is shared by all the VMs.

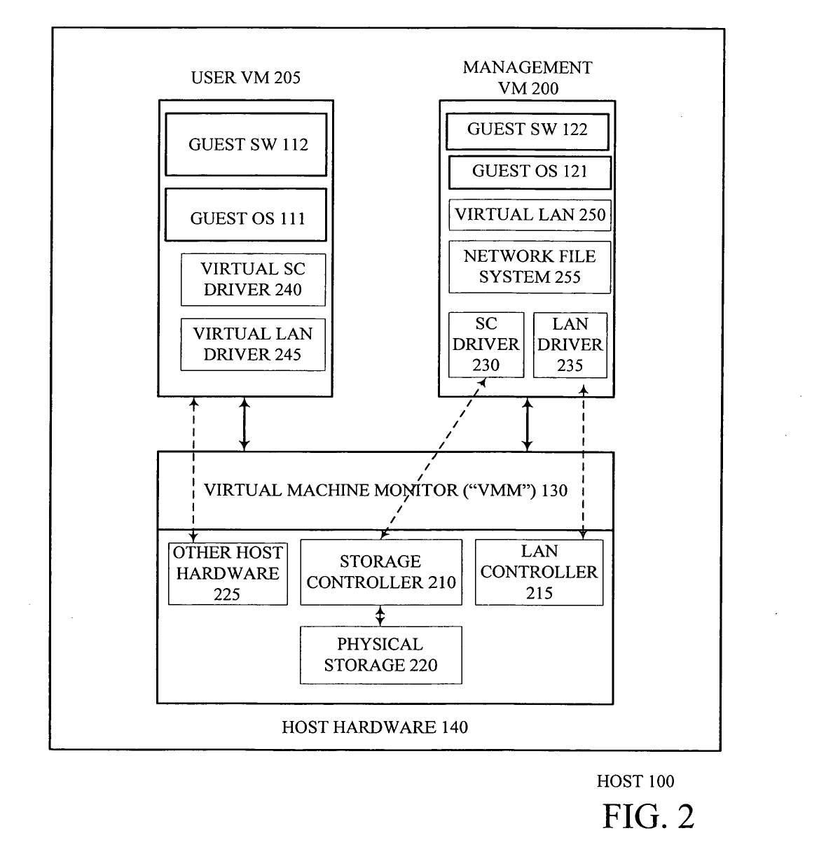

FIG. 2 illustrates an example of a virtualized host according to embodiments of the present invention. As illustrated, VM 120 may be designated a management partition (“Management VM 200”) and VM 110, may be designated a user partition (“User VM 205”). Although only one user partition is illustrated, additional user partitions may be designated without departing from the spirit of embodiments of the present invention. According to the embodiment illustrated in FIG. 2, Host Hardware 140 may include one or more physical storage controllers (illustrated collectively as “Storage Controller 210”), one or more Local Area Network (“LAN”) controllers (illustrated collectively as “LAN Controller 215”), one or more physical storage devices associated with the physical storage controller(s) (illustrated collectively as “Physical Storage 220”) and other host hardware (“Other Host Hardware 225”).

In one embodiment, Storage Controller 210 and LAN Controller 215 may be mapped directly to Management VM 200. Management Partition 200 thus may include a device driver for each controller (illustrated as “SC Driver 230” and “LAN Driver 235”). The mapping of these controllers may be performed according to various techniques without departing from the spirit of embodiments of the present invention. Thus, for example, in one embodiment, the mapping may be implemented using portions of Intel® Corporation's Virtual Technology (“VT”) computing environment (e.g., Intel® Virtualization Technology Specification for the IA-32 Intel® Architecture) that handle Direct Memory Access (“DMA”) and I/O remapping to ensure that devices are mapped directly to Management VM 200. In an alternate example, the storage controller and/or LAN controller device drivers may be “para-virtualized”, i.e., aware that they are running in a virtualized environment and are capable of utilizing features of the virtualized environment to optimize performance and/or simplify implementation of a virtualized environment. Storage Controller 210 may be coupled to Physical Storage 220, and, in one embodiment, Other Host Hardware 225 may be mapped directly to User VM 205.

Management VM 200 may thereafter expose Host 100's file system as a “remote” file system to User VM 205 via (i) the intra-platform LAN and/or (ii) a virtual storage controller device. Intra-platform LANs or virtual LANs are well known to those of ordinary skill in the art and further description thereof is omitted herein in order not to unnecessarily obscure embodiments of the present invention. In either scenario described above, Management Partition 200 may own the file system on Host 100 and perform various tasks such as virus scanning, transparent backup, recovery, provisioning, auditing and inventory without violating OS rules regarding access to Host 100's file system. Similarly, in either embodiment, User VM 205 may have access to a virtual version of Storage Controller 210 and LAN Controller 215 (via “Virtual SC Driver 240” and “Virtual LAN Driver 245”, as illustrated in FIG. 2).

In one embodiment, according to the first scenario described above, User VM 205 may perform a network boot off the intra-platform or “virtual” LAN (illustrated conceptually in FIG. 2 as “Virtual LAN 250”). For example, User VM 204 may utilize a Pre-boot Execution Environment (“PXE”)) to connect to Management VM 200 via a virtual network. Although PXEs are typically implemented to bootstrap an OS stack from a remote network location, the concept may be easily adapted for use within a virtual network on Host 100 (e.g., to bootstrap from a virtual “remote” partition on a standalone host). Once connected, Management VM 200 may host the file system as a network file system (illustrated conceptually in FIG. 2 as “Network File System 255”), which enables concurrent access to data. Specifically, by hosting the file system as a network file system, Management VM 200 may handle concurrent requests according to traditional network file system rules. It is well known to those of ordinary skill in the art that network file systems have various established methods by which data integrity and/or security may be maintained. Thus, as a result of the virtual network connection, User 205 may access data from the network file system via the virtual “remote” network connection and avoid conflict issues that may arise otherwise.

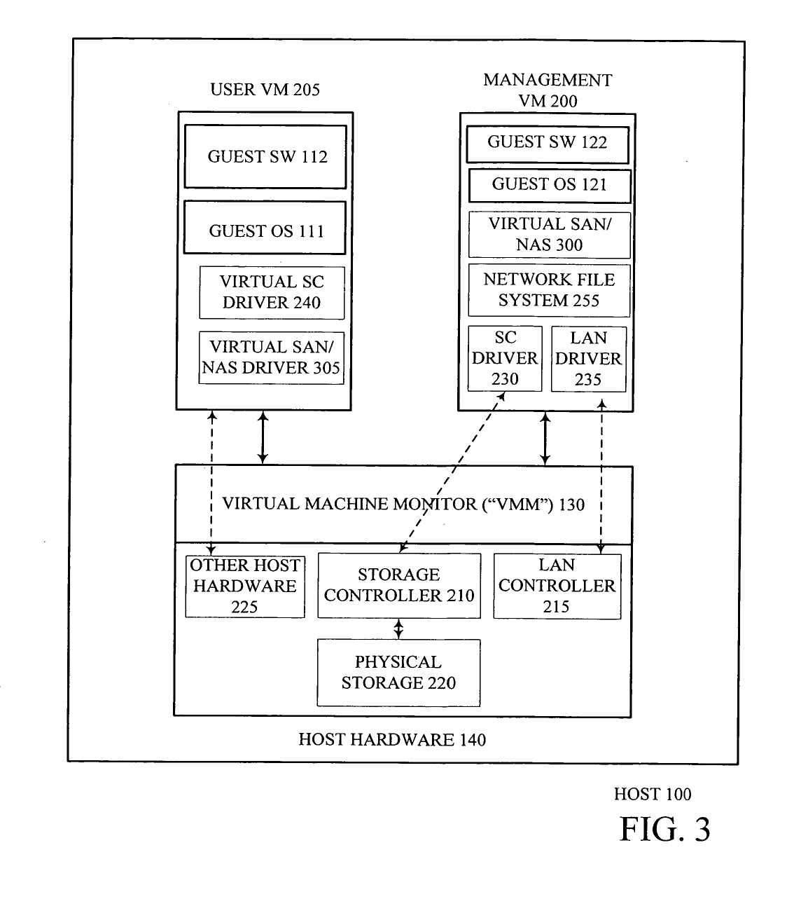

According to the second scenario described above, in an alternative embodiment of the present invention illustrated in FIG. 3, User VM 205 may access content on Host 100 via virtual storage controller devices using networking technology such as Storage Area Network (“SAN”) technology, Network Attached Storage (“NAS”) technology and/or Internet SCSI (“iSCSI”) technology. More specifically, in one embodiment if the present invention, User VM 205 may be linked (via “Virtual SAN/NAS Driver 205”) to Management VM 200 over a virtual SAN and/or NAS (illustrated in FIG. 3 as “Virtual SAN/NAS 300”). iSCSI is an IP-based standard for linking data storage devices over a network and transferring data by carrying SCSI commands over IP networks. iSCSI may, for example, be used to deploy SAN and/or NAS on a LAN and/or WAN. SAN and/or NAS are schemes whereby the storage on a network is detached from the servers on the network. Thus, a typical SAN architecture makes all storage devices on a LAN and/or WAN available to all servers on the network. The server in this scenario merely acts as a pathway between the end user and the stored data (on the storage devices). Similarly, with a NAS device, storage is not an integral part of the server. Instead, in this storage-centric design, the server still handles all of the processing of data but a NAS device delivers the data to the user. A NAS device does not need to be located within the server but can exist anywhere in a LAN and can be made up of multiple networked NAS devices. iSCSI, SAN and/or NAS are well known concepts to those of ordinary skill in the networking art and further description thereof is omitted herein in order not to unnecessarily obscure embodiments of the present invention.

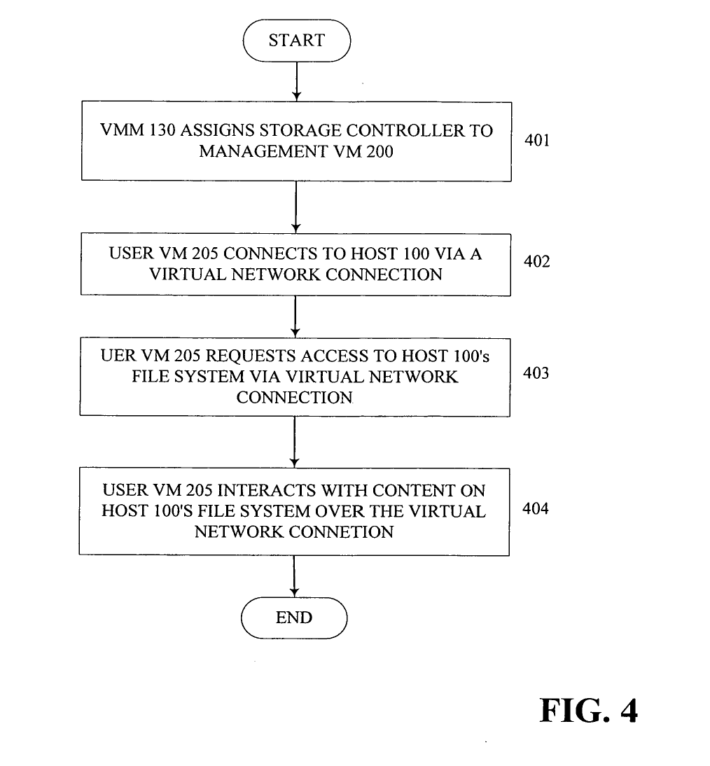

FIG. 4 is a flow chart illustrating an embodiment of the present invention in further detail. Although the following operations may be described as a sequential process, many of the operations may in fact be performed in parallel and/or concurrently. In addition, the order of the operations may be re-arranged without departing from the spirit of embodiments of the invention. In 401, VMM 130 may assign the storage controller and/or LAN controller on Host 100 to Management VM 200. Thereafter, in 402, User VM 205 may establish a virtual LAN, SAN or NAS connection to Management VM 200 to access Host 100's file system. In one embodiment, User VM 205 may establish this connection via a PXE. In 403, User VM requests access the file system over a virtual LAN, SAN or NAS connection,. In 404, User VM 205 may thereafter interact with content on Host 100 as though the content were stored remotely, regardless of the fact that the content is in fact local to the device.

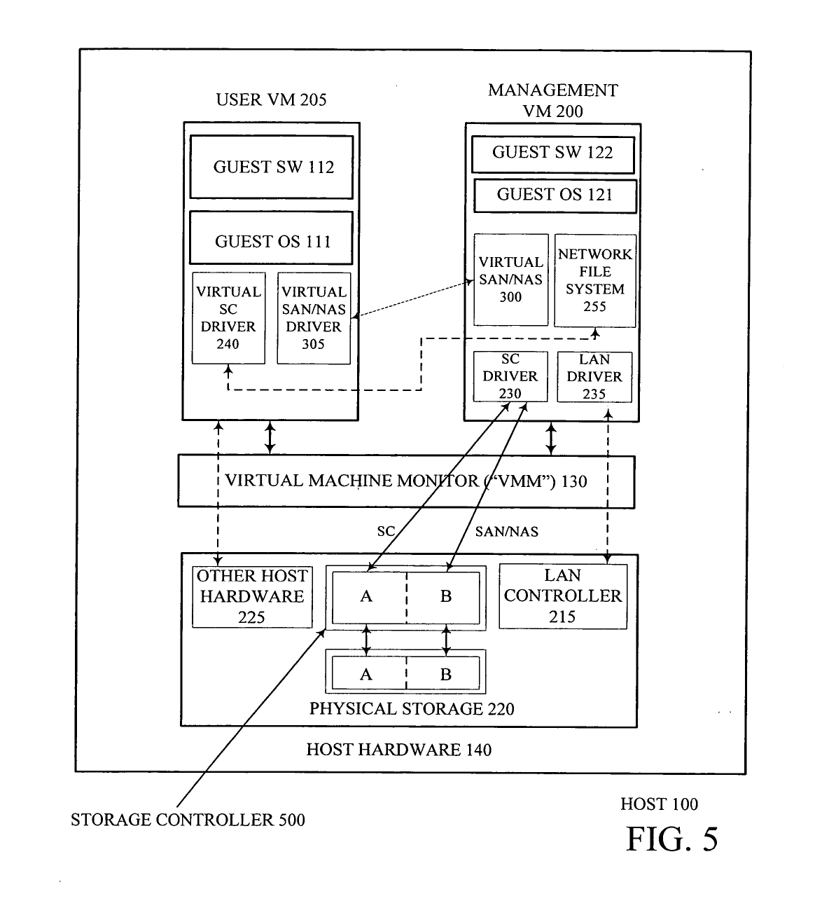

According to an embodiment of the present invention, additional storage controllers may be added to Host 100 to facilitate accelerated performance. FIG. 5 illustrates this embodiment of the present invention. Since Storage Controller 210 in the previously described embodiment(s) is assigned exclusively to Management VM 200, User VM 205 accesses data from Physical Storage 220 (coupled to Storage Controller 210) via the virtual network on Host 100. As a result, all performance critical activities (e.g., accessing page tables, swapping page tables, etc.) occurs across the virtual network, which may result in a performance penalty on Host 100.

According to one embodiment of the present invention, additional storage controllers may be added to Host 100 to address any performance degradation that may result from this scenario. Thus, in one embodiment, an additional storage controller may be added to Host 100 (illustrated in FIG. 5 as Storage Controllers 500A and B). In one embodiment, Storage Controllers 500 A and B may comprise separate components (i.e., separate physical storage controllers). Each storage controller may be mapped to a specific partition. More specifically, Storage Controller 500A may be mapped to Management VM 200 while Storage Controller 500B may be assigned to User VM 205. Both controllers may be coupled to Physical Storage 220 and each controller may correspond to a portion of space on Physical Storage 220 (Storage Controller 500A corresponds to Physical Storage 220A while Storage Controller 500B corresponds to Physical Storage 220B. In this scenario, Management VM 200 has direct access to a portion of the physical drive (Physical Storage 220A) and may utilize this direct connection to conduct all performance critical activity on Host 100.

In an alternate embodiment, however, a “dual-headed” approach may be implemented within a single physical storage controller component. In other words, in one embodiment, Storage Controller 500 may be conceptually divided into two sections, Storage Controller 500A and B, where the controllers exist virtually within the same physical storage controller. Each “virtual” storage controller may correspond to a portion of space on Physical Device 220 (Physical Drive 220 A and B). Additionally, Storage Controller 500A may be mapped to Management VM 200 while Storage Controller 500B is mapped to User VM 205. This dual-headed approach eliminates the need for additional hardware on Host 100 while providing similar benefits.

The dual headed controller scheme above may be implemented in a variety of ways without departing from the spirit of embodiments of the present invention. In other words, the dual headed controller may be implemented in software, hardware, firmware and/or a combination thereof. It will be readily apparent to those of ordinary skill in the art that the implementation decision may affect the degree of performance gain achieved by the dual-headed approach. One example of an implementation may be found in co-pending U.S. application Ser. No. 11/128,934 (Attorney Docket No. P20133), filed on May 12, 2005, entitled, “An Apparatus and Method for Granting Access to a Hardware Interface Shared Between Multiple Software Entities” and assigned to a common assignee.

Embodiments of the present invention may leverage the diskless client architecture described herein to provide additional benefits to Host 100. For example, the existence of a “local” and a “remote” physical storage enables Host 100 to treat the storage areas as distinctly separate entities. In one embodiment, Management VM 200 may be capable of making a selection between the “local” storage and “remote” storage. Thus, for example, if the “local” storage device fails, Management VM 200 may elect to utilize the “remote” storage as a failover mechanism.

The hosts according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
designating a management partition on a host virtual machine (“VM”);
allocating a storage controller to the management partition;
enabling a second partition on the host VM to establish a virtual network connection to the management partition; and
enabling the second partition to access the storage controller via the virtual network connection.

2. The method according to claim 1 wherein enabling a second partition on the host VM to establish the virtual network connection to the management partition further comprises enabling the second partition to boot from the management partition.

3. The method according to claim 2 wherein enabling the second partition to boot from the management partition further comprises enabling the second partition to boot from the management partition according to a Pre-boot Execution Environment (“PXE”) scheme.

4. The method according to claim 3 wherein enabling the second partition on the host VM to establish the virtual network connection to the management partition further comprises configuring a virtual Basic Input Output System (“BIOS”) to boot a PXE across the virtual network connection.

5. The method according to claim 4 wherein enabling the second partition on the host VM to establish the virtual network connection to the management VM further comprises enabling a bootloader on the second partition to boot the PXE across one of the virtual network connection and a remote network connection.

6. The method according to claim 1 wherein the storage controller is coupled to a storage device.

7. The method according to claim 6 further comprising:
allocating a first portion of the storage controller to the management partition;
and allocating a second portion of the storage controller to the second partition.

8. The method according to claim 7 further comprising:
allocating the first portion of the storage device to the management partition, the first portion of the storage device corresponding to the first portion of the storage controller; and
allocating the second portion of the storage device to the second partition, the second partition of the storage device corresponding to the second portion of the storage controller.

9. The method according to claim 8 further comprising the management partition utilizing the first portion of the storage controller and the first portion of the storage device for performance critical activities.

10. The method according to claim 6 further comprising:
allocating an additional storage controller to the second partition;
allocating a first portion of the storage device to the storage controller; and
allocating a second portion of the storage device to the additional storage controller.

11. The method according to claim 1 wherein enabling the second partition to establish a virtual network connection to the management partition further comprises establishing a network connection from the second partition to the management partition based on a network protocol.

12. The method according to claim 11 wherein the network protocol includes one of a Local Area Network (“LAN”) protocol, a Storage Area Network (“SAN”) protocol and a Network Attached Storage (“NAS”) protocol.

13. The method according to claim 12 wherein the management VM includes virtual services that enable a Pre-boot Execution Environment (“PXE”) boot.

14. The method according to claim 13 wherein the virtual services include at least one of a Dynamic Host Control Protocol (“DHCP”) server, a file transfer protocol (“FTP”) server and a network file system.

15. The method according to claim 11 wherein the storage controller is coupled to a storage device on the host VM and to a remote storage device on a network.

16. The method according to claim 15 further comprising the management VM determining whether to store and access data to and from at least one of the storage device on the host VM and the remote storage device on the network.

17. An article comprising a machine-accessible medium having stored thereon instructions that, when executed by a machine, cause the machine to:
designate a management partition on a host virtual machine (“VM”);
allocate a storage controller to the management partition;
enable a second partition on the host VM to establish a virtual network connection to the management partition; and
enable the second partition to access the storage controller via the virtual network connection.

18. The article according to claim 17 wherein the instructions, when executed by the machine, cause the machine to enable the second partition to boot from the management partition.

19. The article according to claim 18 wherein the instructions, when executed by the machine, cause the machine to to boot from the management partition according to a Pre-boot Execution Environment (“PXE”) scheme.

20. The method according to claim 19 wherein enabling the second partition on the host VM to establish the virtual network connection to the management partition further comprises configuring a virtual Basic Input Output System (“BIOS”) to boot a PXE across the virtual network connection.

21. The article according to claim 20 wherein the instructions, when executed by the machine, cause the machine to enable a bootloader on the second partition to boot the PXE across one of the virtual network connection and a remote network connection.

22. The article according to claim 17 wherein the storage controller is coupled to a storage device.

23. The article according to claim 22 wherein the instructions, when executed by the machine, further cause the machine to:
allocate a first portion of the storage controller to the management partition; and
allocating a second portion of the storage controller to the second partition.

24. The article according to claim 23 wherein the instructions, when executed by the machine, further cause the machine to:
allocate the first portion of the storage device to the management partition, the first portion of the storage device corresponding to the first portion of the storage controller; and
allocate the second portion of the storage device to the second partition, the second partition of the storage device corresponding to the second portion of the storage controller.

25. The article according to claim 24 wherein the instructions, when executed by the machine, further cause the management partition to utilize the first portion of the storage controller and the first portion of the storage device for performance critical activities.

26. The article according to claim 25 wherein the instructions, when executed by the machine, further cause the machine to:
allocate an additional storage controller to the second partition;
allocate a first portion of the storage device to the storage controller; and
allocate a second portion of the storage device to the additional storage controller.

27. The article according to claim 17 wherein the instructions, when executed by the machine, further cause the machine to enable the second partition to establish a virtual network connection to the management partition by establishing a network connection from the second partition to the management partition based on a network protocol.

28. A system comprising:
a management virtual machine (“VM”);
a storage controller assigned to the management VM;
a user VM capable of establishing a virtual network connection to the management partition.

29. The system according to claim 28 further comprising:
a storage device coupled to the storage controller, the user VM capable of accessing the storage device via the virtual network connection to the management partition.

30. The system according to claim 29 further comprising a remote storage device, the management VM capable of accessing the remote storage device via the virtual network connection.

31. The system according to claim 30 wherein the management VM includes virtual services to enable a Pre-boot Execution Environment boot.

32. The system according to claim 31 wherein the virtual services comprise at least one of a Dynamic Host Configuration Protocol (“DHCP”) server, a file transfer protocol (“FTP”) server and a network file server.
